(19) United States
(12) Patent Application Publication
(10) Pub. No.: US 2015/0246551 A1
(43) Pub. Date: Sep. 3, 2015

(54) METHOD FOR ADJUSTING COLOR TEMPERATURE OF SURFACE LIGHT-EMITTING ILLUMINATION DEVICE AND PRINTING DEVICE FOR PRODUCING SURFACE LIGHT-EMITTING ILLUMINATION DEVICE

(71) Applicant: MUTOH INDUSTRIES LTD., Setagaya-ku, Tokyo (JP)

(72) Inventors: Yoichi Abe, Tokyo (JP); Tomoo Nakajima, Tokyo (JP)

(73) Assignee: MUTOH INDUSTRIES LTD., Setagaya-ku, Tokyo (JP)

(21) Appl. No.: 14/427,194

(22) PCT Filed: Sep. 9, 2013
(86) PCT No.: PCT/JP2013/074181

§ 371 Date: Mar. 10, 2015

(30) Foreign Application Priority Data
Sep. 20, 2012 (JP) 2012-206623

(51) Int. Cl. B41J 2/21

(52) U.S. Cl. CPC B41J 2/21

(57) ABSTRACT

A surface-emitting illuminating device includes a light guide plate, a light source for emitting light to the interior of the light guide plate, and a light reflection plate and/or a light diffusion plate. The color temperature of the light-emitting face of the prepared surface-emitting illuminating device is measured. When the measured color temperature is not a required color temperature, ink for coloring the light reflection plate and/or light diffuser plate is selected. The selected ink is used to subject the light reflection plate and/or light diffuser plate to a coloring printing by an inkjet printer. The color temperature of the light-emitting face of the surface-emitting illuminating device is measured. Until the measured color temperature of the light-emitting face of the surface-emitting illuminating device is within an allowable range, the color printing of the light reflection plate and/or light diffuser plate is repeatedly corrected.

### TECHNICAL FIELD

The present invention relates to a color temperature adjustment method of a surface-emitting illuminating device and a printing device for preparing a surface-emitting illuminating device by which light entered through a side face of a light guide plate is diffused and uniform light is emitted to a light-emitting surface.

### BACKGROUND ART

A method has been conventionally known to manufacture a light guide plate by setting a front face as an illuminating light illumination face and by forming a reflection printing face on a back face by many printing dots of white ink color only by an inkjet printer (see Patent Publication 1 for example). An edge light-type surface-type light source has been conventionally known to correct unavoidable variation of the spectrum of a light emission source such as an LED by a light guide plate to emit illuminating light (see Patent Publication 2 for example).

Furthermore, a liquid crystal display device has been conventionally known in which a surface of a light diffuser plate includes a colored layer including pigments (see Patent Publication 3 for example).

Furthermore, a surface-type light-emitting structure has been conventionally known including a reflection plate and a diffuser plate in which the diffuser plate or the reflection plate is colored (see Patent Publication 4 for example).

Furthermore, a liquid crystal display device has been conventionally known in which a light guide plate, a light diffuser plate, a light reflection plate, and a colored sheet are sequentially provided (see Patent Publication 5 for example).

### PRIOR ART PUBLICATION

### Patent Publication

Patent Publication 1: Japanese Patent Laid-Open Publication No. H9-68614

### Patent Publication 2: Japanese Patent Laid-Open Publication No. 2002-150821

### Patent Publication 3: Japanese Patent Laid-Open Publication No. 2003-279985

Patent Publication 4: Japanese Patent Laid-Open Publication No. H7-113912
Patent Publication 5: Japanese Patent Laid-Open Publication No. H8-146228

### SUMMARY OF THE INVENTION

### Problem to be Solved by the Invention

There is a surface-emitting illuminating device having a configuration in which a back face of a light guide plate is subjected to a reflection printing by an inkjet printer and a light source is provided in this light guide plate. When a plurality of surface-emitting illuminating devices are prepared in this type of surface-emitting illuminating device, a light-emitting face may be required to have the same color temperature. For example, when a plurality of illuminating devices are collectively arranged to provide a large illuminating light source, a difference in a color temperature for example due to individual difference may be visually annoying, though such a difference is not annoying when each single device is seen. Thus, even when a surface-emitting illuminating device is formed using light guide plates using the same white ink, a slight difference in the color temperature may be caused due to the variation in the performance of light sources such as LEDs. In order to correct the color temperature, subjecting the light guide plate to a newly-corrected reflection printing requires a cost and time. This causes a disadvantage that the surface-emitting illuminating device is prevented from being easily subjected to the color temperature adjustment of the light-emitting face.

The term “color temperature” means a numerical value showing a relative strength of blue-violet light and red color light included in a light source emitting a certain color.

The present invention has an objective of solving the above disadvantage.

### Means for Solving the Problem

In order to achieve the above objective, the present invention is characterized in providing a color temperature adjustment method of a light-emitting face of a surface-emitting illuminating device consisting of a light guide plate, a light source for emitting light to the interior of the light guide plate, and a light reflection plate and/or a light diffuser plate provided to be abutted to the light guide plate.

The method includes:

a process of preparing the surface-emitting illuminating device;
a process of measuring the color temperature of the light-emitting face of the prepared surface-emitting illuminating device to prepare color temperature data;
a process of selecting, when the measured color temperature is not a required color temperature, ink for coloring the light reflection plate and/or light diffuser plate;
a process of using the selected ink to subject the light reflection plate and/or light diffuser plate to a coloring printing by an inkjet printer; and
a process of measuring the color temperature of the light-emitting face of the surface-emitting illuminating device using the color-printed light reflection plate and/or light diffuser plate.

Until the measured color temperature of the light-emitting face of the surface-emitting illuminating device is within an allowable range, the coloring printing of the light reflection plate and/or light diffuser plate is repeatedly corrected.

The present invention is characterized in that the process of selecting ink consists of selecting a single color or a combination from among coloring inks.

The present invention is characterized in that the process of selecting ink is performed so that reference data showing a relation between the shift direction of the color temperature of the surface-emitting illuminating device and the ink type and combination for coloring the light reflection plate and/or light diffuser plate is prepared in advance to select ink based on this reference data.

The present invention is characterized in providing a color temperature adjustment method of a light-emitting face of a surface-emitting illuminating device consisting of a light guide plate, a light source for emitting light to the interior of the light guide plate, and a light reflection plate and/or a light diffuser plate provided to be abutted to the light guide plate.

The method includes:

a process of using coloring inks to prepare a plurality of light reflection plates and/or light diffuser plates including a printing face consisting of a single color or a combination of these inks in advance;
a process of preparing the surface-emitting illuminating device;
a process of measuring the color temperature of the light-emitting face of the prepared surface-emitting illuminating device to prepare color temperature data; a process of selecting, when the measured color temperature is not a required color temperature, the light reflection plate and/or light diffuser plate for correcting color temperature from among the light reflection plates and/or light diffuser plates prepared in advance;
a process of preparing the surface-emitting illuminating device by providing the selected light reflection plate and/or light diffuser plate to be abutted to the light guide plate; and
a process of measuring the color temperature of the light-emitting face of the surface-emitting illuminating device using the selected light reflection plate and/or light diffuser plate.

Until the measured color temperature of the light-emitting face of the surface-emitting illuminating device is within an allowable range, the light reflection plate and/or light diffuser plate is repeatedly selected.

The present invention is characterized in providing a printing device in which printing data stored in a computer is printed on a printing medium by discharging ink through a device body-side recording head to move a recording head relative to the printing medium, comprising: a retention mechanism for retaining a light guide plate and a reflection plate and/or diffuser plate used for a surface-emitting device so that the relative movement to the recording head is possible, a light guide plate printing recording head and a reflection plate and/or diffuser plate printing recording head, a white ink supply section for supplying white ink to a light guide plate printing recording head, and a color ink supply section for supplying color ink to the reflection plate and/or diffuser plate printing recording head. A storage device of a computer or a device body-side control section stores therein printing data for adjusting the color temperature of the light guide plate and printing data for correcting the color temperature for coloring the reflection plate and/or diffuser plate for example.

### Effect of the Invention

According to the present invention, a color temperature or a color of a prepared surface-emitting illuminating device can be easily corrected within a fixed color temperature range.

### BRIEF DESCRIPTION OF THE INVENTION

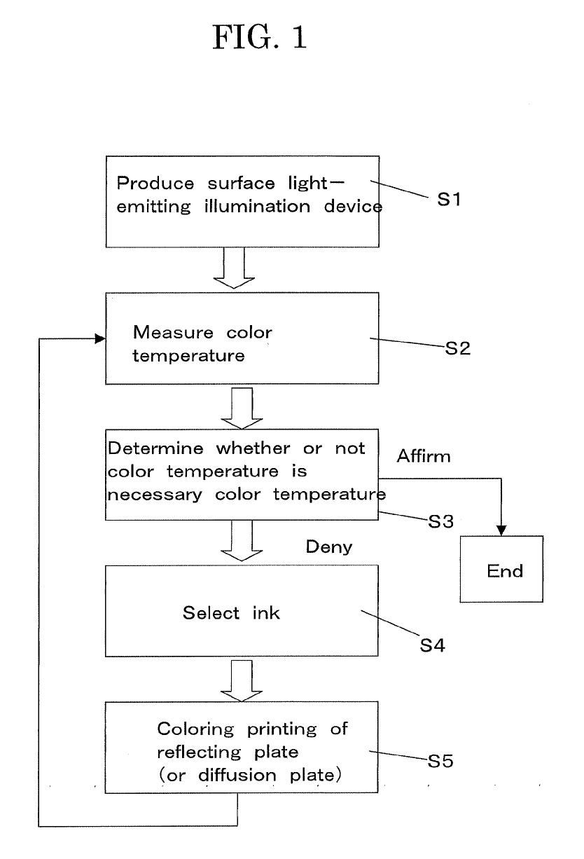

FIG. 1 is an illustration diagram of the present invention.

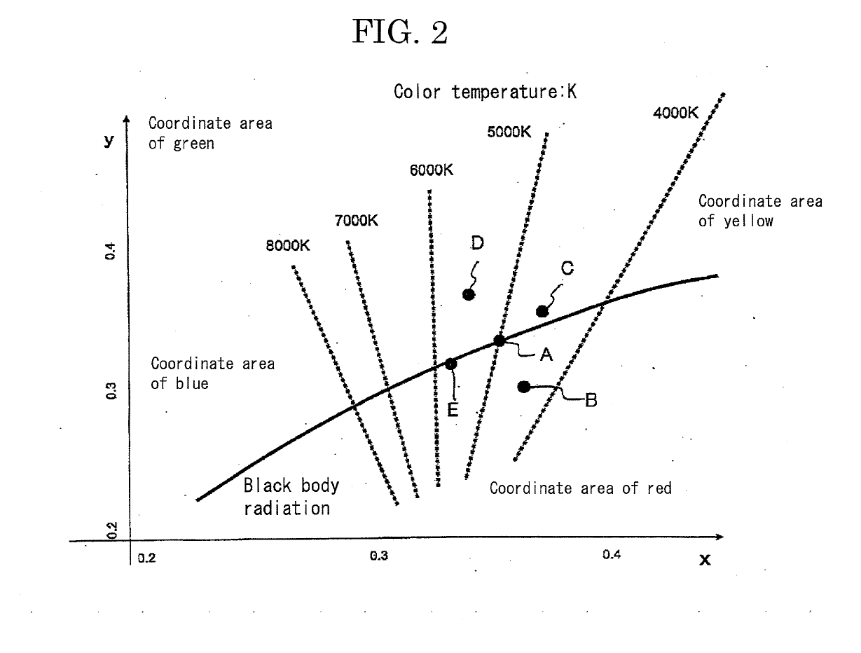

FIG. 2 illustrates the shift of color coordinates due to the coloring of a reflection plate.

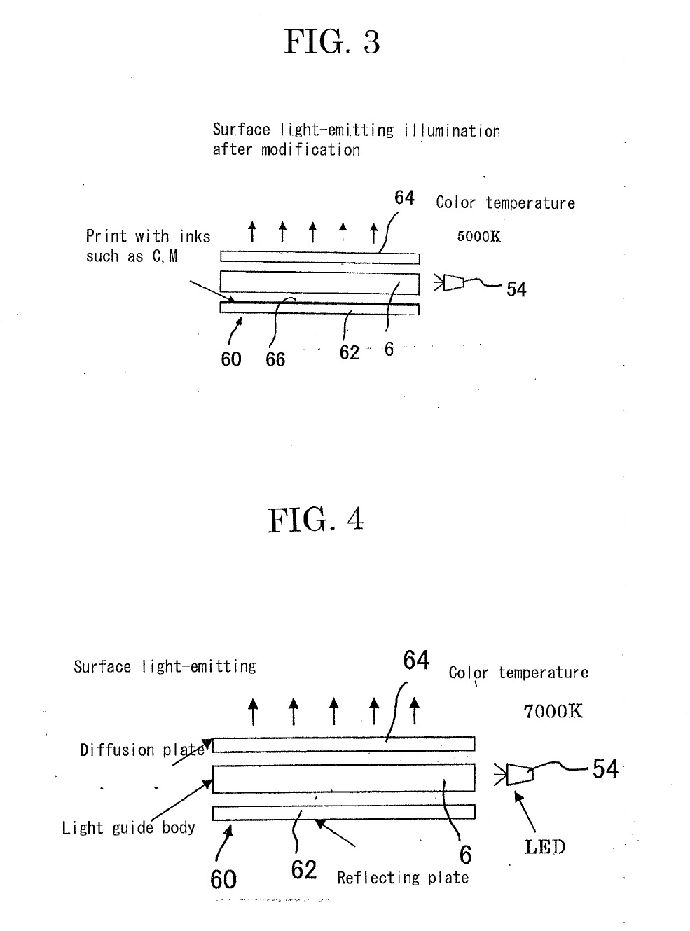

FIG. 3 is an illustration diagram of the present invention.

FIG. 4 is an illustration diagram of the present invention.

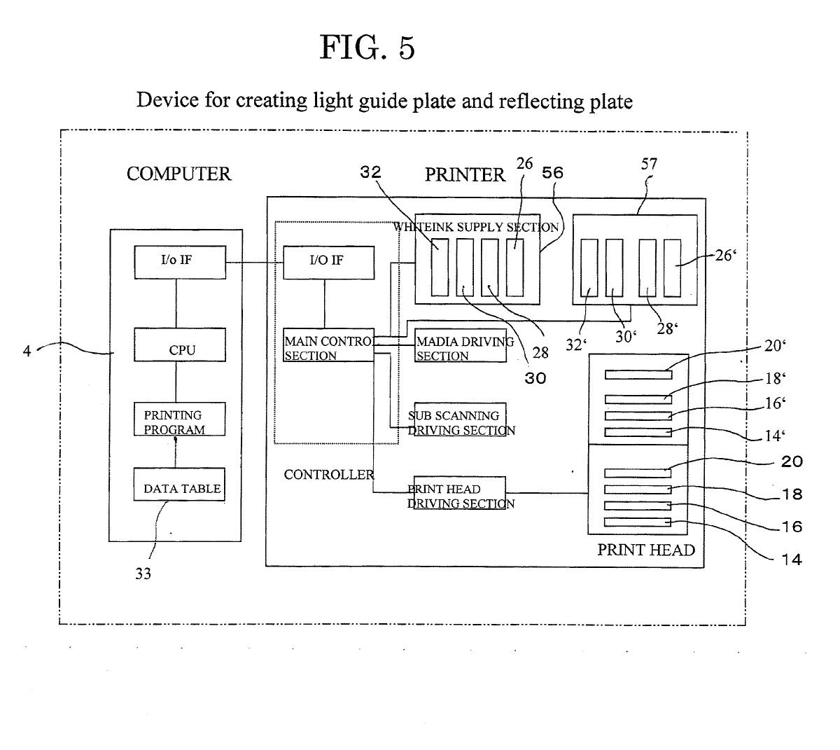

FIG. 5 is a block diagram of the present invention.

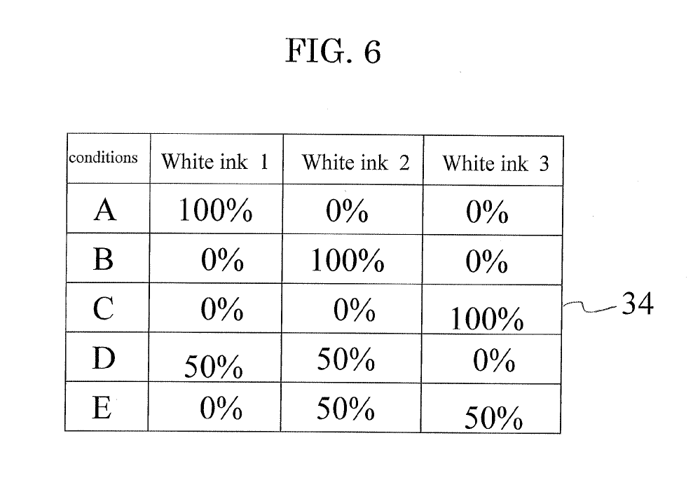

FIG. 6 is an illustration diagram of a data table.

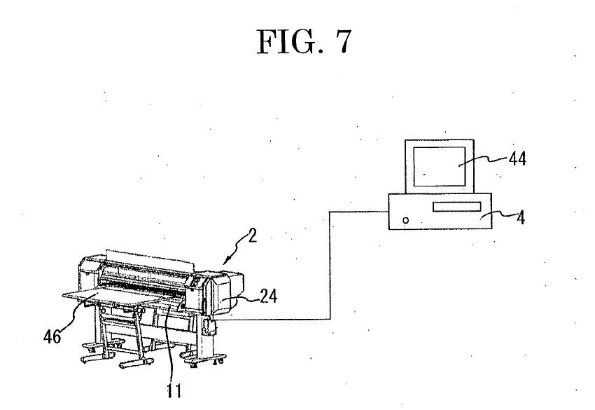

FIG. 7 is an illustration diagram of the present invention.

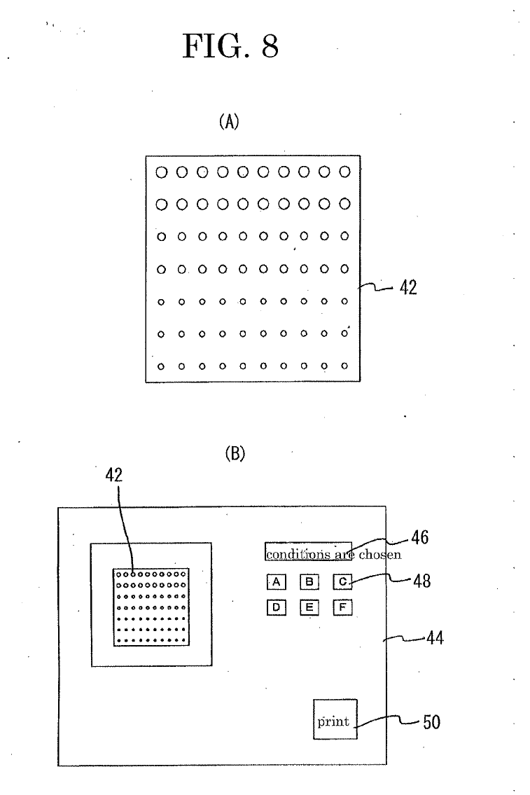

FIG. 8 is an illustration diagram of the present invention.

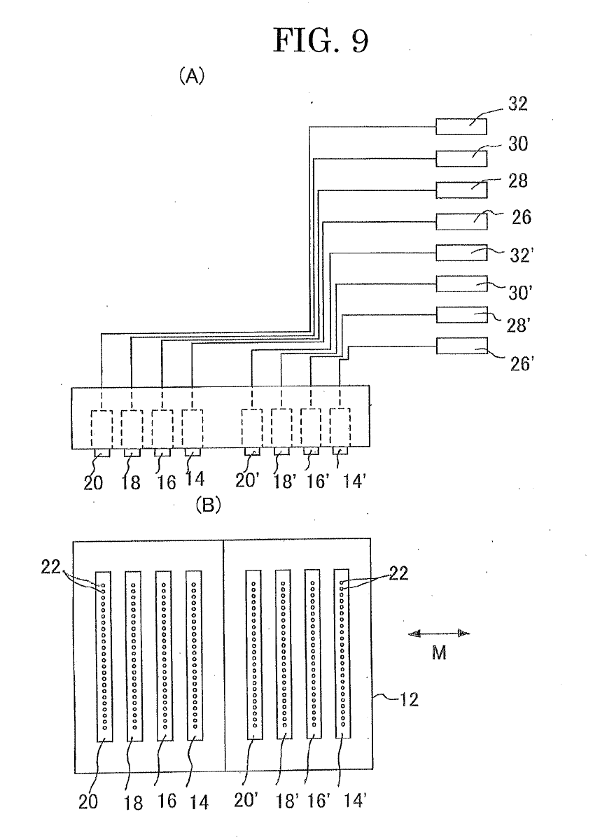

FIG. 9 is an illustration diagram of the present invention.

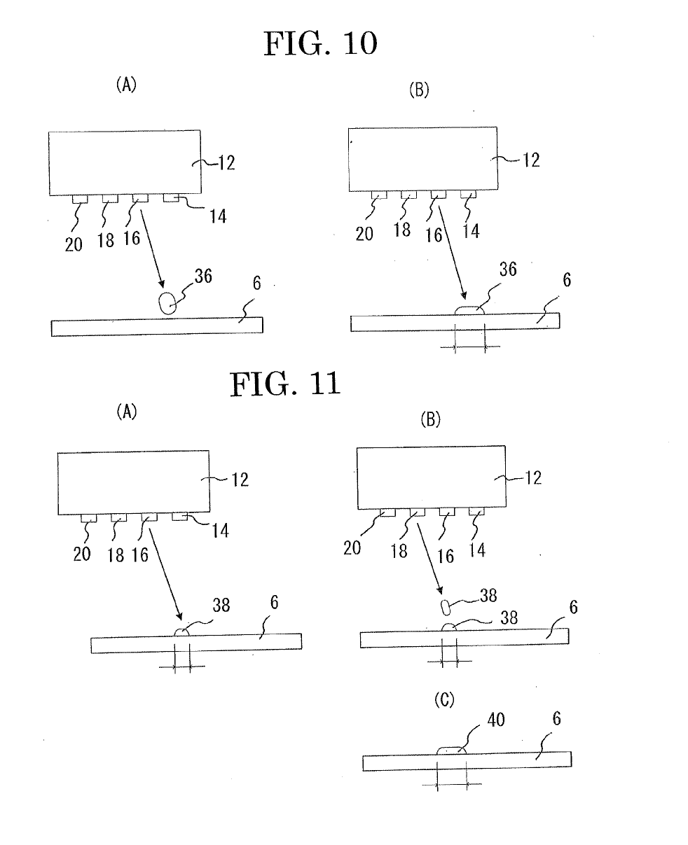

FIG. 10 is an illustration diagram of the present invention.

FIG. 11 is an illustration diagram of the present invention.

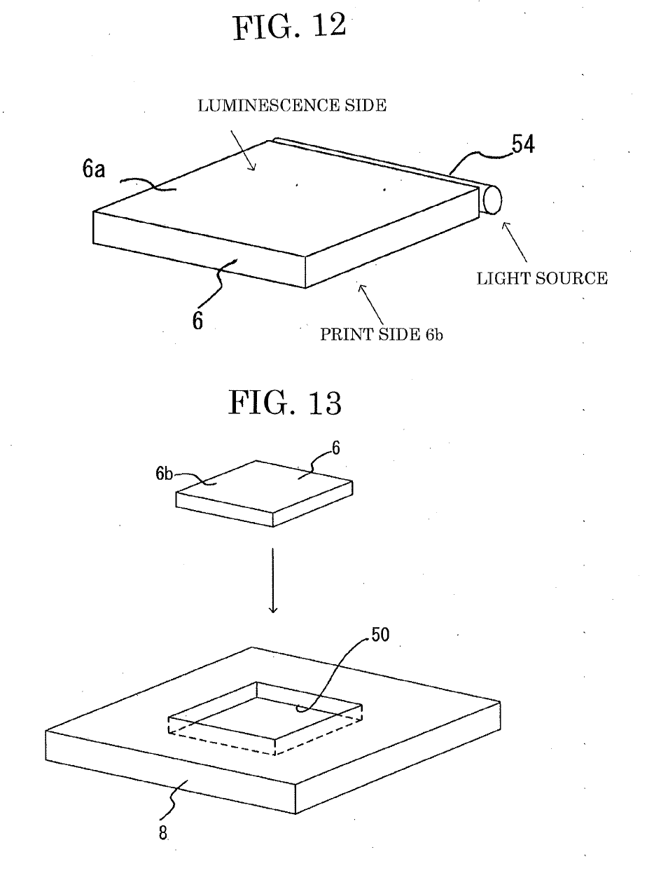

FIG. 12 is an illustration diagram of a light guide plate.

FIG. 13 is an illustration diagram of the present invention.

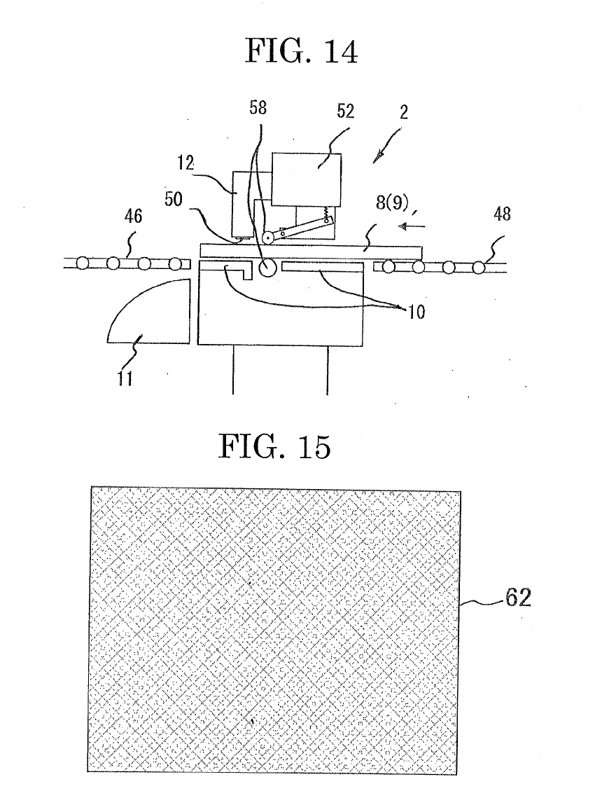

FIG. 14 is an illustration diagram of a printer.

FIG. 15 is an illustration diagram of the present invention.

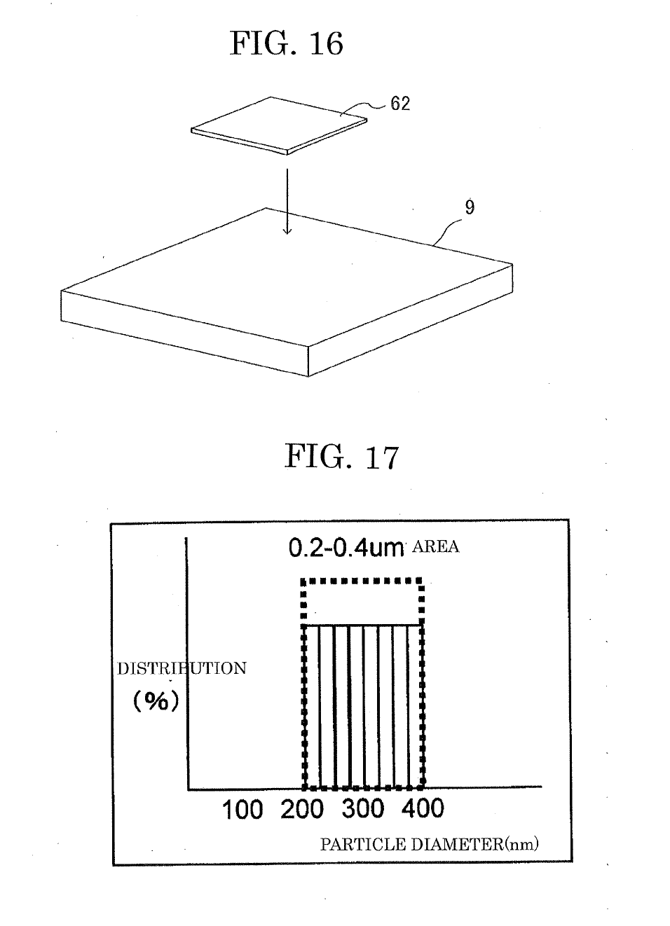

FIG. 16 is an illustration diagram of the present invention.

FIG. 17 is an illustration diagram of the present invention.

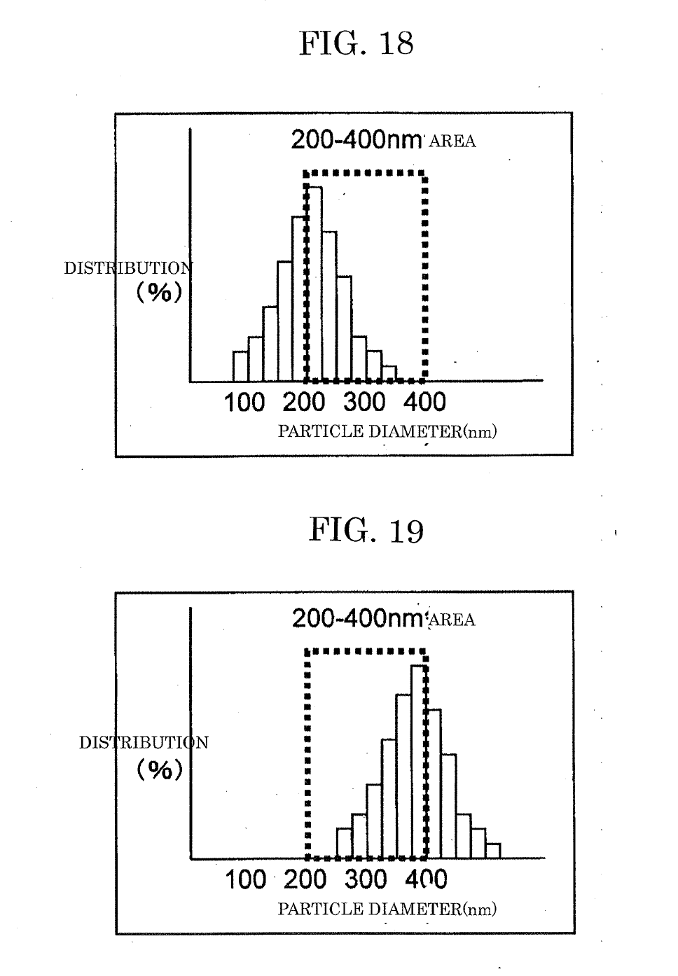

FIG. 18 is an illustration diagram of the present invention.

FIG. 19 is an illustration diagram of the present invention.

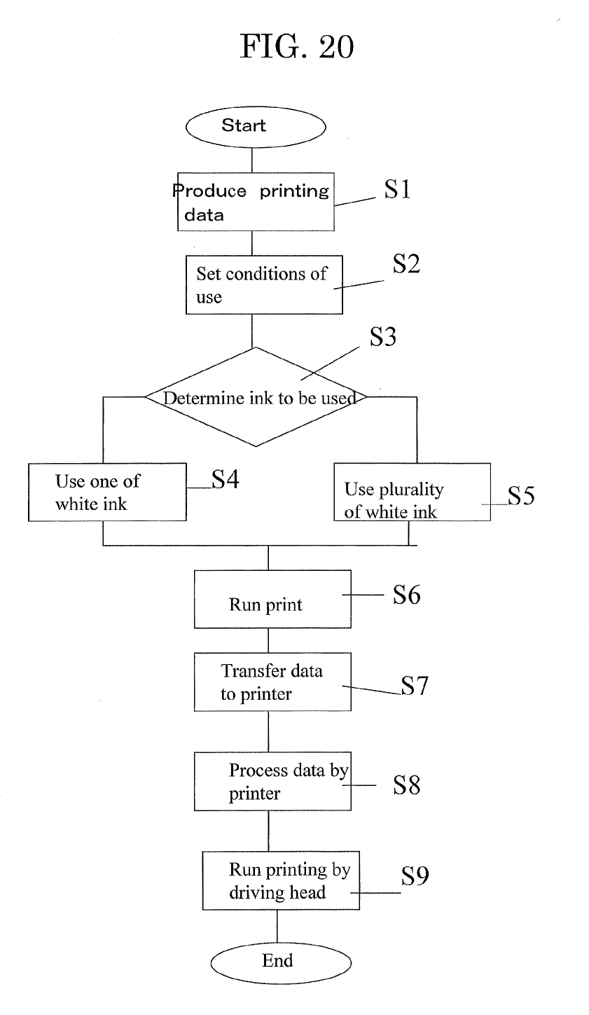

FIG. 20 is a flowchart illustrating the operation of the present invention.

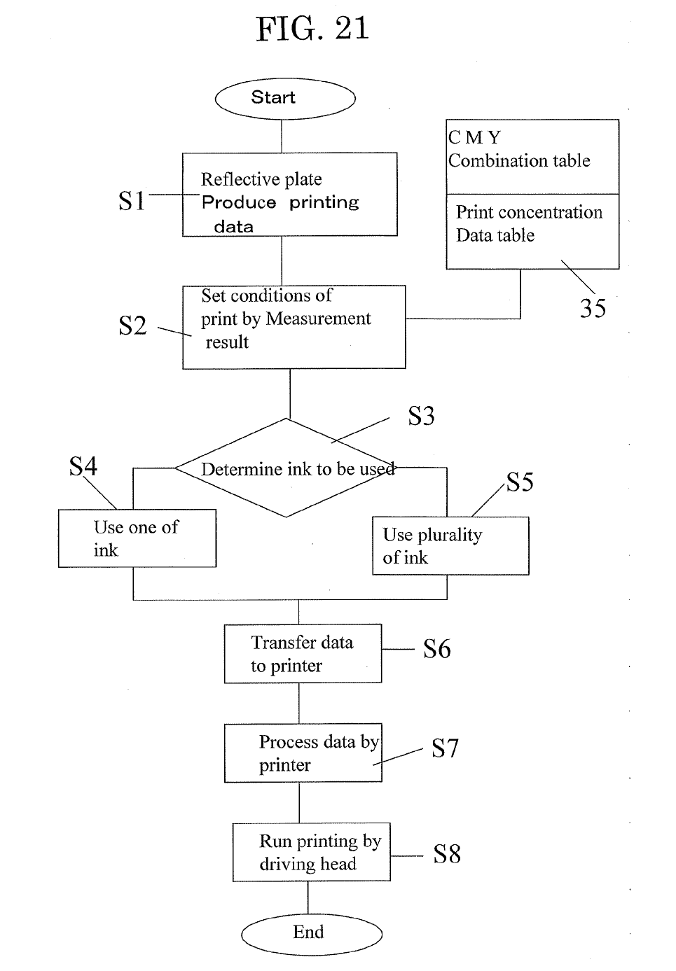

FIG. 21 is a flowchart illustrating the operation of the present invention.

### EMBODIMENT FOR CARRYING OUT THE INVENTION

The following section will describe in detail the configuration of the present invention with reference to the attached drawings. FIGS. 5 and 7 are a schematic view illustrating a light guide plate and a reflection plate printing device consisting of an inkjet printer 2 and a computer 4 (e.g., a personal computer) connected to the controller of the printer 2 via an input/output interface. As shown in FIG. 12, a light guide plate 6 is transported to a platen 10 from a transportation table 48 side as shown in FIG. 14 by a medium driving mechanism 58 while being retained by an engagement concave section 50 of a board-like transportation assistance member 8 so that the back-side printing face 6b faces upward to the light-emitting face 6a. With regard to the light guide plate 6 on the platen 10, a printing section 50 including an inkjet recording head is moved in a main scanning direction orthogonal to the transportation direction while discharging ink through nozzles. The printing data transferred from the computer 4 to the controller of the inkjet printer 2 is printed (or drawn) on the printing face 6b of the light guide plate 6 by the control by software stored in the controller.

The light guide plate 6 for which printing is completed is transported onto the transportation table 46 provided on a guide 11. As shown in FIG. 16, a reflection plate (reflection sheet) 62 is transported to the platen 10 from the transportation table 48 side as shown in FIG. 14 by the medium driving mechanism 58 while placed on and retained by a board-like transportation assistance member 9 so that the printing face faces upward. With regard to the reflection plate 62 on the platen 10, the printing section 50 including an inkjet recording head is moved in the main scanning direction orthogonal to the transportation direction while discharging ink through nozzles. The printing data transferred from the computer 4 to the controller of the inkjet printer 2 is printed (or drawn) on the printing face of the reflection plate 62 by the control by software stored in the controller. The reflection plate 62 for which printing is completed is transported to the transportation table 46 provided on the guide 11.

The platen 10 has thereon a lateral rail 52. The lateral rail 52 is connected to a carriage 12 in a movable manner. This carriage 12 retains, as shown in FIG. 9, a plurality of inkjet recording heads 14, 16, 18, and 20 for printing a light guide plate and a plurality of inkjet recording heads 14′, 16′, 18′, and 20′ for printing a reflection plate. The respective recording heads 14, 16, 18, and 20 as well as 14′, 16′, 18′, and 20′ include many nozzles 22 through which ink is discharged. The respective heads 14, 16, 18, and 20 communicate, as shown in FIG. 9(A), the respective ink tanks 26, 28, 30, and 32 included in a white ink supply section 56 each of which is provided in a body 24 of the printer 2 via an ink supply means such as a tube. The respective heads 14′, 16′, 18′, and 20′ communicate, as shown in FIG. 9(A), the respective ink tanks 26′, 28′, 30′, and 32′ included in a color ink supply section 57 each of which is provided in the body 24 of the printer 2 via an ink supply means such as a tube.

The plurality of recording heads 14, 16, 18, and 20 are parallelly arranged, as shown in FIG. 9(B), so that the printing regions are mutually superposed in the main scanning direction M along the lateral rail 52. The storage device of the computer 4 stores therein software (printing program) for preparing printing data of a light reflection pattern. A data table storage section 33 includes a data table 34 shown in FIG. 6 for preparing a light guide plate. This data table 34 includes combinations of color temperatures and inks set in advance so that light guide plates having many color temperatures can be prepared by using or combining each or a plurality of types of white inks to print a light guide plate. This data table 34 can be used to easily prepare light guide plates having many color temperatures. The printing control software stored in the computer can provide the preparation and correction of the data table 34 for example.

The data table storage section 33 of the computer 4 stores therein a CMY combination table or a printing concentration data table 35 (see FIG. 21) for printing a reflection plate.

The prepared light guide plate 6 is, as shown in FIG. 12, obtained by printing reflection dots or a reflection gradation (fine dots like those of fogged glass) on a flat surface of the printing face 6b of a transparent acrylic plate. The light guide plate 6 functions to provide a situation as if light is emitted from the entire flat surface of the light-emitting face 6a by providing a light source 54 consisting of a light-emitting structure (e.g., a cold-cathode tube or an LED) at the thickness part of the light guide plate 6.

The data table 34 shows a case where three types of white inks 1, 2, and 3 having different color temperatures are prepared. When ink using oxidized titanium is used, white inks having different color temperatures depending on the particle size distribution of oxidized titanium in ink are prepared. When the dispersion of the particle size distribution is changed, a difference in reflection light is provided, causing a difference in a color temperature.

### [Regarding White Ink and Color Temperature]

White ink includes ink pigments of oxidized titanium. Oxidized titanium particles have a property according to which light having a wavelength two times longer than the particle size is reflected most strongly. Ideal white ink is configured so that oxidized titanium has a particle size distribution uniformly existing in a range from 200 nm to 400 nm as shown in FIG. 17. In such a case, such white color is obtained that uniformly reflects the light 400 nm to 800 nm (visible light) having a wavelength two times larger than the particle size of 200 nm to 400 nm. However, in the case of actual white ink, it is rare for the particle size distribution to uniformly exist in a range of 200 nm to 400 nm.

(1) When the most particle size distribution exists at 200 nm (see FIG. 18), white ink strongly reflecting 400 nm light (short wavelength) or blueish white ink having a high color temperature is obtained.
(2) When the most particle size distribution exists at a particle size of 400 nm (see FIG. 19), white ink strongly reflecting 800 nm light (long wavelength) or reddish, yellowish, or greenish white ink having a low color temperature is obtained.

In the color temperature adjustment, these combinations of white inks having different color temperatures (or different oxidized titanium distributions) are used to prepare a light guide plate having a desired color temperature=a desired oxidized titanium distribution=a desired light wavelength region. However, when it is difficult to adjust the color temperature only by the particle size of oxidized titanium, the other particles (e.g., copper phthalocyanine) may be added to obtain desired light wavelength region. The white ink used in this embodiment is added with a small amount of copper phthalocyanine. This addition amount is based on the experiment result in which an appropriate amount is experimentally selected to easily control the color temperature of the ink.

FIG. 17 to FIG. 19 illustrate the distribution image of the particle size of oxidized titanium in the ink in which the horizontal axis shows the particle diameter while the vertical axis shows the distribution level. FIG. 17 shows the distribution of oxidized titanium particles in ideal white ink. FIG. 18 to FIG. 19 show the distribution of oxidized titanium particles in an actual white ink. In FIG. 6, when assuming that the same light source is used and the light guide plate printed under the printing conditions A shown in FIG. 2 has a color temperature of 4500K, then the color temperature is 5000K when the light guide plate is printed under the conditions B and the color temperature is 5500K when the light guide plate is printed under the conditions C. By combining these results, the conditions D provide the color temperature of 4500K to 5000K and the conditions E provide the color temperature of 5000K to 5500K.

FIG. 8 shows the light reflection pattern of the light guide plate in which uniform reflection is provided so that the light reflection pattern has an area increasing while being farther away from the light source. The pattern may be obtained, in addition to by being provided by an increased area, by being printed with same areas having an increased density or by using the combinations thereof.

FIGS. 10 and 11 are an illustration diagram of the printing operation of the inkjet recording head to the light guide plate. The recording head 14 communicates with the ink tank 26 including the white ink 1 provided in the data table 34. The recording head 16 communicates with the ink tank 28 including the white ink 2. The recording head 18 communicates with the ink tank 30 including the white ink 3. The white inks 1, 2, and 3 mutually have different particle size distribution of oxidized titanium in ink and thus have different ink color temperatures.

FIGS. 10(A) and 10(B) show the printing operation under the conditions B shown in the data table 34 of FIG. 2. In FIG. 10(A), a general amount of the ink dot 36 of the white ink 2 is discharged through the nozzle of the recording head 16. The ink dot 36 of 100% of the white ink 2 is formed on the light guide plate 6 in an amount corresponding to 1 dot. Specifically, only the white ink 2 is used for the printing of the entire face.

FIGS. 11(A), 11(B), and 11(C) show the printing operation under the conditions E shown in the data table 34 of FIG. 6. In FIGS. 11(A), 11(B), and 11(C), a half amount of the general amount of the ink dot 38 of the white ink 2 is discharged through the nozzle of the recording head 16 and is printed on the light guide plate 6. Next, the recording head 18 discharges the half amount of the general amount of the ink dot 38 of the white ink 3 onto the previously-printed ink dot 38 of the white ink 2. Then, the two ink dots 38 and 38 are printed in a superposed manner in an amount corresponding to 1 dot. A printing 40 corresponding to 1 dot through the superposed printing is composed of 50% of the white ink 2 and the 50% of the white ink 3. Specifically, the white ink 2 and the white ink 3 are combined to print the entire face. This ink discharge control is printed by preparing a plurality of printing waveforms or driving voltages for driving the head and by selecting and using a required driving waveform or driving voltage.

Next, with reference to the flowchart of FIG. 20, a step will be described to subject the printing face of the light guide plate to a reflection printing.

First, an operator in Step 1 uses software for preparing a reflection pattern of a light guide plate to prepare a reflection face printing data 42 on the computer 4. This printing data 42 is displayed on a display 44 of the computer 4. This display 44 displays a data input display 48 showing white ink use conditions A, B, C, D, E, and F. The use conditions A, B, C, D, E, and F on the display 48 correspond to the data table 34.

Next, the operator in Step 2 refers to the display 48 on the display 44 of the computer 4 to select use conditions and uses an input means such as a mouse to click a condition selection button display 46 to input use conditions (i.e., printing conditions) to the computer 4. Based on the selected conditions, the computer refers to the data table 34 to select to-be-used inks 1, 2, and 3 in Step 3. The computer 4 in Step 4 selects a mode for using one white ink or the computer 4 in Step 5 selects a mode for using a plurality of white inks. When a printing button 50 is executed through the computer 4 in Step 6, the printing data is transferred from the computer 4 to the printer 2 (Step 7). Thereafter, after the data is processed by the printer 2 (Step 8), the recording head is driven in the main scanning direction and the white ink is printed on the light guide plate 6 under the selected printing conditions (Step 9).

In the embodiment, the technique has been described to print white inks of 50% having different color temperatures at the same position. However, the invention is not limited to this. Specifically, 100%+50% printing also may be performed or another white ink having the same color temperature is prepared (white 1, white 1, white 2, and white 3) and these inks may be printed at the same position as required to thereby provide the printing of 100%+100%=200%. Thus, the color temperature can be further changed. When a plurality of white inks having the same color temperature are not prepared, such a printing control may be performed to subject the same position to printing two times.

An inkjet printer is characterized in that the respective positions can be printed with different inks. Thus, even when a plurality of light sources having a varied brightness are used, each position may be printed at a different color temperature suitable for the position to thereby correct the difference easily.

The data table 34 may be provided in a memory included in the controller of the printer 2. In this case, the printing conditions may be firstly set by the printer 2 so that only the printing data can be sent from the computer 4. FIG. 3 illustrates an entire structure of a surface-emitting illuminating device 60. The light guide plate 6 is combined with the reflection plate 62 and a diffuser plate 64 and is further attached with the light source 54 consisting of LED to thereby prepare a surface-emitting illuminating device used for the back lighting of television or a liquid crystal monitor or other applications.

Next, with reference to FIG. 1, the process will be described to adjust the color temperature of the surface-emitting illuminating device.

First, a light source having an appropriate color temperature (e.g., LED) is used to prepare the surface-emitting illuminating device 60 shown in FIG. 3 so that the light-emitting face has a desired color temperature (Step 1). Next, the color temperature of the light-emitting face of the surface-emitting illuminating device 60 is measured using a known measurement tool (Step 2). Next, whether or not the color temperature of the surface-emitting illuminating device 60 is the required color temperature is determined (Step 3). When the color temperature is not the required color temperature, in order to allow the light-emitting face of the surface-emitting illuminating device 60 to have a color temperature region close to a required color temperature, the inkjet printer is used to print dots or gradation (fine dots like those in fogged glass) on the reflection plate 62 or the diffuser plate 64 by specifying coloring inks (e.g., yellow (Y), magenta (M), or cyan (C)) to thereby form a coloring printing face 66 (Step 5).

By coloring the reflection plate 62 or the diffuser plate 64, the color coordinate of the white color light of the light-emitting face of the surface-emitting illuminating device 60 can be shifted. Thus, the color temperature of the white color light of the surface-emitting illuminating device can be prepared in a required region. In this case, the reflection plate 62 or the diffuser plate 64 is colored by a single color among cyan, yellow, or magenta or a combination of these inks to thereby shift the color coordinate freely. FIG. 2 is a chromaticity diagram illustrating the shift of the color coordinate due to the coloring of the reflection plate for example in which the horizontal axis shows an X value while the vertical axis shows a Y value. In FIG. 2, A shows the color coordinate of the light guide plate subjected to a reflection printing by white ink of oxidized titanium having an average particle diameter of 300 nm. B shows one example of the color coordinate of the surface-emitting illuminating device when the light guide plate having a reflection face by the same white ink of 300 nm and the reflection plate with a magenta coloring are used. C shows one example of the color coordinate of the surface-emitting illuminating device when the light guide plate having a reflection face by the same white ink of 300 nm and the reflection plate with a yellow coloring are used.

D shows one example of the color coordinate of the surface-emitting illuminating device 60 when the light guide plate having a reflection face by the same white ink of 300 nm and the reflection plate with yellow and cyan coloring are used. E shows one example of the color coordinate of the surface-emitting illuminating device 60 when the light guide plate having a reflection face by the same white ink of 300 nm and the reflection plate with a cyan coloring are used. The coloring of the reflection plate can be performed by a single color in order to shift the color coordinate of the surface-emitting illuminating device 60 from the position A in the directions B, C, and E. The shift in the direction D requires the combination of cyan and yellow. When magenta is combined with yellow, the color coordinate shifts in a direction between B and C. Similarly, the color coordinate of the surface-emitting illuminating device 60 also can be shifted from the position of A in directions between C and D, between D and E, and between E and B. In this manner, it is possible to identify a combination of directions or colors required to move a position at a certain coordinate value to a desired position.

The chromaticity diagrams are prepared in a large amount by an experiment. Based on this experiment data, color coordinate shift data is prepared that shows a relation between the selection of CMY pigments colored to the reflection plate and the color coordinate shift direction and a relation between the concentration of the CMY pigments and the color coordinate shift direction. Based on this data, CMY pigment inks for obtaining a required color temperature are specified. This ink is used to color the reflection plate. Next, the color temperature of the surface-emitting illuminating device 60 using the colored reflection plate is measured (Step 2). If the color temperature is within a region of a required color temperature, then the color temperature adjustment processing is completed. When the required color temperature is not obtained, the processing returns to Steps 4 and 5 to repeat the color temperature adjustment processing until the required color temperature is obtained. Another configuration also may be used in which CMY inks are used to prepare many color-printed light reflection plates and/or light diffuser plates using a single color from CMY inks or a combination of the inks so that, when the measured color temperature of the surface-emitting illuminating device is not a required color temperature, selection can be made from among these light reflection plates and/or light diffuser plates to use the selected light reflection plate and/or light diffuser plate to prepare the surface-emitting illuminating device to thereby correct the color temperature of the light-emitting face of the surface-emitting illuminating device.

Next, with reference to the flowchart of FIG. 21, a step will be described to subject the printing face of the reflection plate to a coloring printing.

First, the operator uses software to prepare the coloring pattern of the reflection plate in Step 1 to prepare the reflection plate printing data on the computer 4. Next, the operator in Step 2 refers to a data table 35 based on the measurement result to input printing conditions (e.g., a combination of CMY or a printing concentration). Based on the inputted printing conditions, the computer determines in Step 3 ink to be used. The computer 4 in Step 4 selects a mode for using one coloring ink. Alternatively, the computer 4 in Step 5 selects a mode for using a plurality of coloring inks. When the print button is executed through the screen of the computer 4 in Step 6, printing data is transferred from the computer 4 to the printer 2. Thereafter, the data is processed by the printer 2 (Step 7). Then, the recording head is driven in the main scanning direction and printing is performed on the reflection plate 62 by the ink under the selected printing conditions (Step 8).

### DESCRIPTION OF REFERENCE NUMERALS

2 Inkjet printer
4 Computer
6 Light guide plate
8 Transportation assistance member
9 Transportation assistance member
10 Platen
12 Carriage
14 Recording head
16 Recording head
18 Recording head
20 Recording head
22 Nozzle
24 Body
26 Ink tank
28 Ink tank
30 Ink tank
32 Ink tank
34 Data table
35 Data table
36 Ink dots
38 Ink dots
40 Ink dots
42 Printing data
44 Display
46 Transportation table
48 Transportation table
50 Printing section
52 Lateral rail
54 Light source
56 White ink supply section
58 Medium driving mechanism
60 Surface-emitting illuminating device
62 Reflection plate
64 Diffuser plate
66 Coloring printing face

What is claimed is:

1. A color temperature adjustment method of a light-emitting face of a surface-emitting illuminating device consisting of a light guide plate, a light source for emitting light to the interior of the light guide plate, and a light reflection plate and/or a light diffusion plate provided to be abutted to the light guide plate, comprising:
a process of preparing the surface-emitting illuminating device;
a process of measuring the color temperature of the light-emitting face of the prepared surface-emitting illuminating device to prepare color temperature data;
a process of selecting, when the measured color temperature is not a required color temperature, ink for coloring the light reflection plate and/or light diffuser plate;
a process of using the selected ink to subject the light reflection plate and/or light diffuser plate to a coloring printing by an inkjet printer; and
a process of measuring the color temperature of the light-emitting face of the surface-emitting illuminating device using the color-printed light reflection plate and/or light diffuser plate,
wherein:
until the color temperature of the light-emitting face of the surface-emitting illuminating device is within an allowable range, the coloring printing of the light reflection plate and/or light diffuser plate is repeatedly corrected.

2. The color temperature adjustment method of a surface-emitting illuminating device according to claim 1, wherein the process of selecting ink consists of selecting a single color or a combination from among coloring inks.

3. The color temperature adjustment method of a surface-emitting illuminating device according to claim 1, wherein the process of selecting ink is performed so that reference data showing a relation between the shift direction of the color temperature of the surface-emitting illuminating device and the ink type and combination for coloring the light reflection plate and/or light diffuser plate is prepared in advance to select ink based on this reference data.

4. A color temperature adjustment method of a light-emitting face of a surface-emitting illuminating device consisting of a light guide plate, a light source for emitting light to the interior of the light guide plate, and a light reflection plate and/or a light diffusion plate provided to be abutted to the light guide plate, comprising:
a process of using coloring inks to prepare a plurality of light reflection plates and/or light diffuser plates including a printing face consisting of a single color or a combination of these inks in advance;
a process of preparing the light-emitting illuminating device;
a process of measuring the color temperature of the light-emitting face of the prepared surface-emitting illuminating device to prepare color temperature data;
a process of selecting, when the measured color temperature is not a required color temperature, the light reflection plate and/or light diffuser plate for correcting color temperature from among the light reflection plates and/or light diffuser plates prepared in advance;
a process of preparing the surface-emitting illuminating device by providing the selected light reflection plate and/or light diffuser plate to be abutted to the light guide plate; and
a process of measuring the color temperature of the light-emitting face of the surface-emitting illuminating device using the selected light reflection plate and/or light diffuser plate, wherein
until the measured color temperature of the light-emitting face of the surface-emitting illuminating device is within an allowable range, the light reflection plate and/or light diffuser plate is repeatedly selected.

5. A printing device in which printing data stored in a computer is printed on a printing medium by discharging ink through a device body-side recording head to move the recording head relative to the printing medium, comprising: a retention mechanism for retaining a light guide plate and a reflection plate and/or diffuser plate used for a surface-emitting device so that the relative movement to the recording head is possible, a light guide plate printing recording head, a reflection plate and/or diffuser plate printing recording head, a white ink supply section for supplying white ink to a light guide plate printing recording head, and a color ink supply section for supplying color ink to the reflection plate and/or diffuser plate printing recording head, wherein a storage device of a computer or device a body-side control section stores therein printing data for adjusting the color temperature of the light guide plate and printing data for correcting the color temperature for coloring the reflection plate and/or diffuser plate for example.
